(19) United States
(12) Patent Application Publication
(10) Pub. No.: US 2026/0320349 A1
(43) Pub. Date: Oct. 15, 2026

(54) SIGNAL GENERATION APPARATUS, SIGNAL GENERATION SYSTEM, SIGNAL GENERATION METHOD AND PROGRAM

(71) Applicant: NIPPON TELEGRAPH AND TELEPHONE CORPORATION, Tokyo (JP)

(72) Inventors: Takuhiro KANEKO, Musashino-shi (JP); Hirokazu KAMEOKA, Musashino-shi (JP); Ko TANAKA, Musashino-shi (JP); Shogo SEKI, Musashino-shi (JP)

(73) Assignee: NIPPON TELEGRAPH AND TELEPHONE CORPORATION, Tokyo (JP)

(21) Appl. No.: 19/101,205

(22) PCT Filed: Sep. 6, 2022
(86) PCT No.: PCT/JP2022/033402

§ 371 Date: Feb. 4, 2025

(51) Int. Cl. G06N 3/045

(52) U.S. Cl. CPC G06N 3/045

(57) ABSTRACT

A signal generation device includes: a multiple-feature generation unit that generates a plurality of different first intermediate features on the basis of input features using a plurality of different first neural network in parallel; a parameter sharing unit that generates a plurality of different second intermediate features on the basis of the plurality of different first intermediate features using a plurality of second neural networks sharing at least some of parameters in parallel; and a merging processing unit that merges the plurality of different second intermediate features as an output feature. The parameter sharing unit may collect at least some of the plurality of different first intermediate features in tensor data and collectively generate at least some of the plurality of different second intermediate features on the basis of the tensor data.

### TECHNICAL FIELD

The present invention relates to a signal generation device, a signal generation system, a signal generation method, and a program.

### BACKGROUND ART

Sequence signals (for example, sound signals, acoustic signals, or text sequences), multidimensional signals (for example, still images or moving images), sensor signals, or a combination of any of the above signals, for example, may be input to a signal generation system. The signal generation system generates a predetermined target signal as an output signal on the basis of an input signal. The target signal is, for example, a sequence signal (for example, a sound signal, an acoustic signal, or a text sequence), a multidimensional signal (for example, a still image or a moving image), a sensor signal, or a combination of any of the above signals.

As representative tasks of generating a sound signal as a target signal, there are text-sound synthesis and sound conversion. The signal generation system includes modules (signal generation devices) of a neural network in one or more stages from an input stage to an output stage. In the text-sound synthesis and sound conversion, the signal generation system may execute the following processing A1 and processing A2, for example.

### Processing A1:

The signal generation system estimates an intermediate representation between an input signal (an input feature of the signal generation device in the input stage) and an output signal (target signal) on the basis of the input signal. In the text-sound synthesis, for example, the signal generation system estimates the intermediate representation on the basis of an input text sequence. In sound conversion, for example, the signal generation system estimates the intermediate representation on the basis of a feature (input sound feature) extracted from the input sound signal.

### Processing A2:

The signal generation system generates a target signal (target sound signal) as an output signal (an output feature of the signal generation device in the output stage) on the basis of the estimated intermediate representation.

The intermediate representation is a feature (such as a spectrogram) obtained by applying a time-frequency conversion (short-time Fourier transform, a wavelet transform, or the like) based on a basis function to the sound signal, for example. The intermediate representation may be a feature (such as a mel spectrogram) obtained by further scale-converting the feature.

The intermediate representation may be a feature (such as a cepstrum or a mel cepstrum) obtained by applying time-frequency conversion (such as Fourier transform) based on a basis function to a spectrogram, a mel spectrogram, or the like. The intermediate representation may be another feature obtained by applying a predetermined function (for example, a function expressed using a neural network, a signal processing function, or the like) to the sound signal or any of the above features. The intermediate representation may be a combination of any of the above features.

Note that the intermediate representation may not be explicitly estimated. In other words, the processing A1 and the processing A2 may be consistent processing (indivisible processing).

Also, Non Patent Document 1 discloses a signal generation system using a neural network as a signal generation system that generates sound signals. The signal generation system disclosed in Non Patent Document 1 includes, as a signal generation device, a module (component) called multi-receptive field fusion (MRF).

FIG. 13 is a diagram illustrating a configuration example of a signal generation device 10 (a module of multi-receptive field fusion). M (“M” is an integer that is equal to or greater than 1) signal generation devices 10 are included in vertical columns in one or more stages from an input stage to an output stage of the signal generation system. The signal generation device 10 includes a plurality of different intermediate feature generation units 101 (neural networks) in parallel. Furthermore, the signal generation device 10 includes an addition processing device 102.

Parameters (for example, kernel sizes) in neural networks of machine learning models in intermediate feature generation units 101 “gᵢ” (“i” is an integer that is 1 to N; “N” is an integer that is equal to or greater than 2 and represents the number of intermediate feature generation units 101 in FIG. 13) are different from each other.

In a case where the above “processing A1” and the above “processing A2” are divisible processing, the plurality of different intermediate feature generation units 101 acquire an input feature “hⁱⁿ” from the signal generation device 10 (module) in the previous stage in the above “processing A2”. The plurality of different intermediate feature generation units 101 generate a plurality of different intermediate features “hᵢ” (hᵢ=gᵢ (hⁱⁿ), i={1, . . . , N)} on the basis of the input feature “hⁱⁿ”.

In the above “processing A2”, the addition processing device 102 adds a plurality of different intermediate features “hᵢ”. The addition processing device 102 generates an addition result of a plurality of different intermediate features as an output feature “h^{out}=Σ^{N}ᵢ₌₁ hᵢ”. The addition processing device 102 outputs the output feature to the signal generation device 10 (module) in the subsequent stage.

As described above, a plurality of different machine learning models (intermediate feature generation units 101) having neural networks with different parameters are used in parallel in the signal generation device 10 for multi-receptive field fusion. As a result, the ability of the machine learning model to express the feature of the input sound signal can be improved as compared with a case where a single machine learning model having a neural network of the same parameter is used (in a case where N=1) in the multi-receptive field fusion. In other words, the signal generation system into which the multi-receptive field fusion module has been introduced can generate a high-quality target sound signal.

### CITATION LIST

### Non Patent Document

Non Patent Document 1: Jungil Kong, Jaehyeon Kim, and Jaekyoung Bae, “HiFi-GAN: Generative Adversarial Networks for Efficient and High Fidelity Speech Synthesis,” in Adv. NeurIPS, 2020.

### SUMMARY OF INVENTION

### Technical Problem

However, since a plurality of different machine learning models having neural networks with different parameters are used in parallel in the multi-receptive field fusion, there is a problem that the ability of the machine learning model to express the feature of the input signal cannot be improved in a case where an increase in the number of parameters is curbed.

In view of the above circumstances, an object of the present invention is to provide a signal generation device, a signal generation system, a signal generation method, and a program capable of improving the ability of a machine learning model to express a feature of an input signal while curbing an increase in the number of parameters of neural networks in machine learning models.

### Solution to Problem

An aspect of the present invention is a signal generation device including: a multiple-feature generation unit that generates a plurality of different first intermediate features on the basis of input features using a plurality of different first neural networks in parallel; a parameter sharing unit that generates a plurality of different second intermediate features on the basis of the plurality of different first intermediate features using a plurality of second neural networks sharing at least some of parameters in parallel; and a merging processing unit that merges the plurality of different second intermediate features as an output feature.

An aspect of the present invention is a signal generation system including: one or more signal generation devices, in which the signal generation device includes a multiple-feature generation unit that generates a plurality of different first intermediate features on the basis of input features using a plurality of different first neural networks in parallel, a parameter sharing unit that generates a plurality of different second intermediate features on the basis of the plurality of different first intermediate features using a plurality of second neural networks sharing at least some of parameters in parallel, and a merging processing unit that merges the plurality of different second intermediate features as an output feature.

An aspect of the present invention is a signal generation method that is executed by a signal generation device, the method including: a step of generating a plurality of different first intermediate features on the basis of input features using a plurality of different first neural networks in parallel; a step of generating a plurality of different second intermediate features on the basis of the plurality of different first intermediate features using a plurality of second neural networks sharing at least some of parameters; and a step of merging the plurality of different second intermediate features as an output feature.

An aspect of the present invention is a program that causes a computer to execute: a procedure of generating a plurality of different first intermediate features on the basis of input features using a plurality of different first neural networks in parallel; a procedure of generating a plurality of different second intermediate features on the basis of the plurality of different first intermediate features using a plurality of second neural networks sharing at least some of parameters in parallel; and a procedure of merging the plurality of different second intermediate features as an output feature.

### Advantageous Effects of Invention

According to the present invention, it is possible to improve the ability of the machine learning model to express a feature of an input signal while curbing an increase in the number of parameters of neural networks in machine learning models.

### BRIEF DESCRIPTION OF DRAWINGS

FIG. 1 A diagram illustrating a configuration example of a signal generation system according to the first embodiment.

FIG. 2 A diagram illustrating a configuration example of a signal generation device according to the first embodiment.

FIG. 3 A diagram illustrating a first example of a neural network that executes residual modeling processing according to the first embodiment.

FIG. 4 A diagram illustrating a second example of the neural network that executes residual modeling processing according to the first embodiment.

FIG. 5 A flowchart illustrating an operation example of the signal generation system according to the first embodiment.

FIG. 6 A diagram illustrating a configuration example of a signal generation device in a case where all parameters are shared in a predetermined same stage according to a second modification example of the first embodiment.

FIG. 7 A diagram illustrating a configuration example of a signal generation device in a case where some of parameters are shared in another same stage according to the second modification example of the first embodiment.

FIG. 8 A diagram illustrating a configuration example of a signal generation device in a case where all parameters are shared in a predetermined same stage and some of parameters are shared in another same stage according to the second modification example of the first embodiment.

FIG. 9 A diagram illustrating an example of advantages of signal generation systems in a comparative example, the first embodiment, and the second modification example.

FIG. 10 A diagram illustrating a configuration example of a signal generation system according to a second embodiment.

FIG. 11 A diagram illustrating a configuration example of a signal generation system according to a third embodiment.

FIG. 12 A diagram illustrating a hardware configuration example of the signal generation system in each of the embodiments.

FIG. 13 A diagram illustrating a configuration example of the signal generation device.

### DESCRIPTION OF EMBODIMENTS

First, a signal generation system including a signal generation device (module) for multi-receptive field fusion will be described as a comparative example of a signal generation system in each embodiment.

### COMPARATIVE EXAMPLE

A signal generation system (hereinafter, referred to as a “signal generation system in a comparative example”) including a signal generation device 10 in a comparative example generates a predetermined target signal on the basis of an input signal. The target signal is, for example, a sequence signal (for example, a sound signal, an acoustic signal, or a text sequence), a multidimensional signal (for example, a still image or a moving image), a sensor signal, or a combination of any of the above signals. The signal generation system in the comparative example acquires an input text signal (in the case of text-sound synthesis) or an input sound signal (in the case of sound conversion) as an example of the input signal. The target signal is, for example, a sequence signal (for example, a sound signal, an acoustic signal, or a text sequence), a multidimensional signal (for example, a still image or a moving image), a sensor signal, or a combination of any of the above signals. In the text-sound synthesis or the voice conversion, the signal generation system in the comparative example generates a target sound signal as an example of the target signal.

Furthermore, the signal generation system in the comparative example may execute the above “processing A1” and the above “processing A2” as processing that can be divided into two stages (divisible processing), or may execute the above “processing A1” and the above “processing A2” as consistent processing (indivisible processing). Hereinafter, the signal generation system in the comparative example executes the above “processing A1” and the above “processing A2” as processing that can be divided into two stages.

The above “processing A2” is so-called vocoder processing. The signal generation device 10 in the signal generation system in the comparative example includes a neural network as a module of a vocoder (neural vocoder). The neural network is, for example, a convolutional neural network (CNN), a recurrent neural network (RNN), a transformer network, an attention neural network, a fully connected neural network (FNN), or a combination thereof. Hereinafter, a case where the signal generation device 10 includes a convolutional neural network as a module of a vocoder will be described as an example.

Sound signals are complex signals containing several thousands to several tens of thousands of samples per second. In order for a signal generation system capable of faithfully reproducing such complicated sound signals to be realized, a machine learning model having a neural network with high representation ability is required. The signal generation device 10 in the comparative example includes a plurality of intermediate feature generation units 101. The plurality of intermediate feature generation units 101 include mutually different convolutional neural networks. Therefore, the signal generation device 10 in the comparative example can improve the ability of the machine learning model to express a feature of an input signal (for example, an input text signal or an input sound signal) as compared with a case where a single machine learning model (a machine learning model including only a convolutional neural network of any one intermediate feature generation unit 101 out of the plurality of different intermediate feature generation units 101) is used (a case where N=1 (simple method)).

The signal generation device 10 in the comparative example generates an output feature on the basis of the input feature in the above “processing A2”. Hereinafter, the input feature may be an input signal (input data) of the signal generation system, or may be a feature obtained by applying one or more functions (neural networks, signal processing functions, or the like) to the input signal of the signal generation system.

Each neural network “gᵢ” of the multi-receptive field fusion (MRF) may have units (layers) such as one or more convolutional layers (for example, one-dimensional convolutional layers) or one or more activation function layers (for example, rectified linear unit layers (ReLUs) or a leaky-rectified linear unit layer (Leaky ReLU)) in an arbitrary order. Furthermore, each neural network “gᵢ” may have a recurrent neural network, a transformer network, an attention neural network, a fully connected neural network, or a combination thereof.

Hereinafter, an output of the plurality of different neural networks “gᵢ” in a case where each unit of the plurality of different neural networks “gᵢ” of the multi-receptive field fusion is used alone or continuously will be referred to as a “feature A”. Hereinafter, a result of transformation such as identity transform or linear transform executed in parallel will be referred to as a “feature B”.

The signal generation device 10 in the comparative example may add the feature A and the feature B. It is thus possible to model a residual of the input signal. As an example, the processing in which the residual modeling is executed once in the input/output of the neural network “gᵢ” has been described above. The present invention is not limited thereto, and the residual modeling may be executed once or more between one or more layers determined in advance from among a plurality of layers in the case where the neural network “gᵢ” is a multilayer neural network, for example.

A dilated convolutional layer (dilated convolution) may be used as a part or all of the convolutional layer in the signal generation device 10 in the comparative example. It is thus possible to expand the receptive field of the convolutional neural network even in a case where the number (size) of parameters of the convolutional neural network is less than a predetermined number.

Note that, in a case where the size of the input signal of the signal generation system in the comparative example is different from the size of the output signal of the signal generation system in the comparative example, in a case where the size of the input signal or the size of the output signal of the signal generation system in the comparative example is different from the size of the intermediate representation of the signal generation system in the comparative example, or in a case where reduction or extension of information regarding a predetermined dimension is performed, the signal generation system in the comparative example may include the signal generation device 10 (a module of multi-receptive field fusion) and a module (not illustrated) that executes upsampling processing or downsampling processing on a feature of arbitrary one or more stages from the input stage to the output stage of the signal generation system. The upsampling processing or the downsampling processing may be executed a plurality of times in a divided manner. The signal generation system in the comparative example may further include a module that executes other processing.

Furthermore, the signal generation device 10 and a neural network (for example, a convolutional neural network, a recurrent neural network, a transformer network, an attention neural network, or a fully connected neural network) with another configuration may be combined in the signal generation system in the comparative example.

As a machine learning method of the signal generation device 10 in the comparative example, a machine learning method using a generation model such as generative adversarial networks (GANs), an autoregressive model, a flow model, a diffusion probabilistic model, or a variational autoencoder (VAE) or a combination thereof, for example, is used.

As another machine learning method of the signal generation device 10 in the comparative example, a machine learning method based on an arbitrary measure (for example, an L1 distance, an L2 distance, a Wasserstein distance, a Hinge function, or a combination thereof), for example, may be used. In addition, a machine learning method based on a combination of a generation model and an arbitrary measure may be used.

In the signal generation device 10 in the comparative example, it is possible to improve the ability of the machine learning model to express the feature of the input signal (for example, the input text signal or the input sound signal) as compared with a case where a single machine learning model (a machine learning model including only any one neural network among the plurality of different neural networks as multi-receptive field fusion) is used (in a case where N=1) by the plurality of different neural networks (intermediate feature generation units 101) being used in parallel as multi-receptive field fusion.

However, since the plurality of different machine learning models having neural networks with different parameters are used in parallel in the signal generation device 10 in the comparative example, it is not possible to improve the ability of the machine learning model to express the feature of the input signal in a case where an increase in the number (size) of the parameters is curbed.

### (Overview of Each Embodiment)

A signal generation system in each embodiment includes one or more signal generation devices (modules) in which at least some of parameters are shared, in vertical columns in one or more stages from an input stage to an output stage. The signal generation system in each embodiment generates a predetermined target signal (output signal) on the basis of an arbitrary input signal (for example, a sequence signal (such as a sound signal, an acoustic signal, or a text sequence, for example), a multidimensional signal (for example, a still image or a moving image), a sensor signal, or a combination of any of the above signals). The target signal is, for example, a sequence signal (for example, a sound signal, an acoustic signal, or a text sequence), a multidimensional signal (for example, a still image or a moving image), a sensor signal, or a combination of any of the above signals.

The signal generation system in each embodiment may execute the above “processing A1” and the above “processing A2” as processing (divisible processing) that can be divided into two stages or may execute the above “processing A1” and the above “processing A2” as consistent processing (indivisible processing).

Hereinafter, a signal generation system in the first embodiment executes the above “processing A1” and the above “processing A2” as processing (divisible processing) that can be divided into two stages. A representation generation device (a module that generates an intermediate representation) in the first embodiment generates an intermediate representation in the above “processing A1”. A signal generation device (the module that generates a feature) in the first embodiment executes the following “processing B1”, the following “processing B2”, and the following “processing B3” using a neural network in the above “processing A2”. In this manner, the signal generation device in the output stage in the first embodiment generates an output signal in the above “processing A2”.

For example, a signal generation system in the second embodiment executes the above “processing A1” and the above processing “A2” as processing (divisible processing) that can be divided into two stages. A signal generation device (a module that generates a feature) in the second embodiment executes the following “processing B1”, the following “processing B2”, and the following “processing B3” using a neural network in the above “processing A1”. In this manner, the signal generation device in the second embodiment generates an intermediate representation (target intermediate representation) in the above “processing A1”. An output generation device (a module that generates an output signal) in the second embodiment generates a target signal (output signal) on the basis of the intermediate representation in the above “processing A2”.

For example, a signal generation system in the third embodiment executes the above “processing A1” and the above “processing A2” in consistent processing. In other words, a signal generation system in the third embodiment does not explicitly estimate an intermediate representation (target intermediate representation). A signal generation device (a module that generates a feature) in the third embodiment executes the following “processing B1”, the following “processing B2”, and the following “processing B3” using a neural network in the above “processing A1” and the above “processing A2”. In this manner, the signal generation device in the third embodiment generates an output signal (target signal) on the basis of an input signal.

### Processing B1:

A signal generation device (module) according to the embodiment acquires an input feature “hⁱⁿ” from a preceding stage. The signal generation device according to the embodiment generates N different first intermediate features “h¹ᵢ=fᵢ(hⁱⁿ)” on the basis of the input feature “hⁱⁿ” using N different first neural networks “fᵢ” (i={1, . . . , N}). Here, “N” is an integer that is equal to or greater than two and represents the number of neural networks used in parallel. The first neural networks “fᵢ” are neural networks that are lighter than the second neural networks “gᵢ” (which will be described later). In a case where “fᵢ” and “gᵢ” are one-dimensional convolutional neural networks, for example, a one-dimensional convolutional neural network (for example, a one-dimensional convolutional neural network with a kernel size “1”) with a smaller kernel size than that of “gᵢ” may be used for “fᵢ”. Also, in a case where “fᵢ” and “gᵢ” are one-dimensional convolutional neural networks including one or more convolutional layers, a one-dimensional convolutional neural network with a smaller total number of convolutional layers than that of “gᵢ” (for example, a one-dimensional convolutional neural network the total number of convolutional layers of which is 1) may be used for “fᵢ”. Furthermore, in a case where “fᵢ” and “gᵢ” are one-dimensional convolutional neural networks, a one-dimensional convolutional neural network with a smaller number of connections of the convolutional layers in a channel direction than that of “gᵢ” may be used for “fᵢ”. The signal generation device according to the embodiment thus increases variations of the input feature. In other words, the signal generation system according to the embodiment generates the N different first intermediate features “h¹ᵢ” as N variations (diversity) of the input features “hⁱⁿ”.

### Processing B2:

The signal generation device according to the embodiment generates N different second intermediate features “h²ᵢ=gᵢ (h¹ᵢ)” on the basis of the N different first intermediate features “h¹ᵢ” using N second neural networks “gᵢ” (i={1, . . . , N}). Here, the N second neural networks “gᵢ” share at least some of parameters. An increase in number of the parameters is thus curbed.

### Processing B3:

The signal generation device according to the embodiment generates an output feature “h^{out}” by merging N different second intermediate features “h²ᵢ=gᵢ (h¹ᵢ)”. Here, the signal generation device according to the embodiment executes predetermined transformation processing on a result of combining the N different second intermediate features in a feature dimension direction. For example, the signal generation device according to the embodiment executes predetermined transformation processing on the result of combining the N different second intermediate features using a neural network that is lighter than the second neural network “gᵢ”. Hereinafter, the light neural network means, for example, a one-dimensional convolutional neural network with a small kernel size, a one-dimensional convolutional neural network with a small total number of convolutional layers, or a one-dimensional convolutional neural network with a small number of connections of the convolutional layers in the channel direction. Hereinafter, the small kernel size means that the kernel size is one, for example. Hereinafter, the small total number of convolutional layers means that the total number of the convolutional layers is one, for example. Hereinafter, the small number of connections means that the number of connections is equal to or less than a predefined number, for example. Note that the signal generation device according to the embodiment may generate the output feature “h^{out}” by adding the N different second intermediate features “h²ᵢ”. The signal generation device according to the embodiment outputs the output feature to the subsequent stage.

Embodiments of the present invention will be described in detail with reference to the drawings.

### First Embodiment

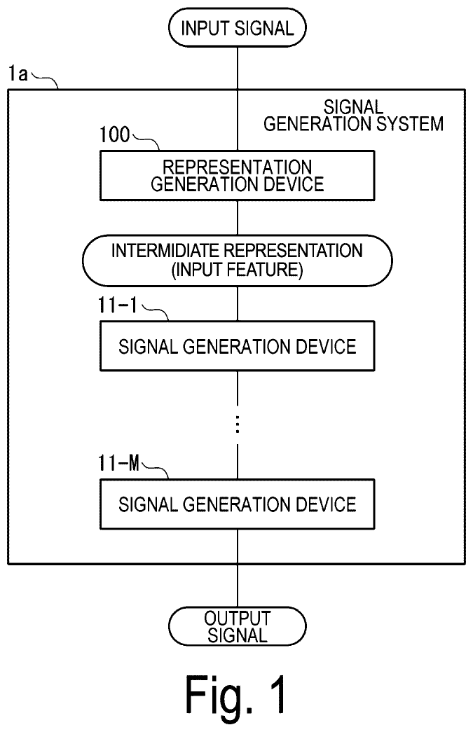

FIG. 1 is a diagram illustrating a configuration example of a signal generation system 1a according to the first embodiment. The signal generation system 1a is a system that generates an output signal (target signal) on the basis of an arbitrary input signal. The signal generation system 1a includes a representation generation device 100 and M (“M” is an integer that is equal to or greater than one) signal generation devices 11 in vertical columns. Note that the signal generation system 1a may further include one or more signal generation devices 10 in a vertical column with respect to the signal generation devices 11. In addition, the signal generation system 1a may include one or more modules (neural networks or signal processing functions, for example) other than the signal generation device 10 and the signal generation devices 11 in one or more arbitrary positions (for example, a preceding stage or a subsequent stage of the predefined one or more signal generation devices 11).

In the first embodiment, the signal generation system 1a explicitly estimates intermediate representations (target intermediate representations) on the basis of an arbitrary input signal and generates an output signal (target signal) on the basis of the estimated intermediate representations (target intermediate representations).

The arbitrary input signal is, for example, a sequence signal (for example, a sound signal, an acoustic signal, or a text sequence), a multidimensional signal (for example, a still image or a moving image), a sensor signal, or a combination of any of the above signals. In the text-sound synthesis, the signal generation system 1a acquires an input text signal as an example of the input signal. In the sound synthesis, the signal generation system 1a acquires the input sound signal as an example of the input signal. The target signal is, for example, a sequence signal (for example, a sound signal, an acoustic signal, or a text sequence), a multidimensional signal (for example, a still image or a moving image), a sensor signal, or a combination of any of the above signals. In the text-sound synthesis or the sound conversion, the signal generation system 1a generates a target sound signal as an example of the output signal (target signal).

The representation generation device 100 generates intermediate representations (for example, spectrograms or the like) in the above “processing A1”. A signal generation device 11-1 generates an output feature of the signal generation device 11-1 on the basis of an intermediate representation generated by the representation generation device 100 in the above “processing A2”. A signal generation device 11-M generates an output feature of the signal generation device 11-M on the basis of an input feature from a signal generation device 11-(M−1) (an output feature of the signal generation device 11-(M−1)) in the above “processing A2”.

Next, a machine learning method will be described.

As a generation model for the machine learning method in the signal generation devices 11, a generation model such as a generative adversarial network, an autoregressive model, a flow model, a spreading probability model, or a variational autoencoder, or a combination thereof, for example, is used.

As another machine learning method of the signal generation devices 11, a method based on an arbitrary measure (for example, an L1 distance, an L2 distance, a Wasserstein distance, a Hinge function, or a combination thereof), for example, may be used. In addition, a method based on a combination of a generation model and an arbitrary measure may be used as another machine learning method of the signal generation devices 11.

In a case where a generative adversarial network is used as a machine learning method of an identifier (not illustrated) and the signal generation devices 11, the adversarial loss “L_{adv}(D; G)” represented by Expression (1) and the adversarial loss function “L_{adv}(G; D)” represented by Expression (2) are used.

$$\begin{matrix}[ Math . 1 ] & \\ {ℒ}_{a d v} ( D ; G ) = {𝔼}_{( x , s )} [ {( D ( x ) - 1 )}^{2} + {( D ( G ( s ) ) )}^{2} ] , & ( 1 )\end{matrix}$$

$$\begin{matrix}[ Math . 2 ] & \\ {ℒ}_{a d v} ( G ; D ) = {𝔼}_{s} [ {( D ( G ( s ) - 1 ) )}^{2} ] , & ( 2 )\end{matrix}$$

Here, “G” represents the group of the signal generation devices 11 (the signal generation devices 11-1 to 11-M). Note that a predetermined signal generation device (for example, the signal generation device 10 or one or more modules (for example, neural networks or signal processing functions) other than the signal generation device 10 and the signal generation devices 11)) may be included in the preceding stage or the subsequent stage of one or more arbitrary signal generation devices 11 in the group of the signal generation devices 11. “s” represents the intermediate representation (target intermediate representation) input to the signal generation device 11-1. The intermediate representation is, for example, a mel spectrogram. “G(s)” represents a fake (product) target signal. The fake target signal is an output signal generated by the group of the signal generation devices 11. “x” represents a real target signal (target sound signal). “D” represents an identifier (not illustrated) that identifies whether the target signal is a real target signal or a fake target signal. “D(x)” represents an identification result as to whether the target signal is a real target signal or a fake target signal.

In addition, pair data “(x, s)” of the target signal “x” and the target intermediate representation “s” is used as learning data for the machine learning model. Here, learning data including one or more pieces of pair data is used. Note that in a case where the group of signal generation devices 11 that performs the processing of the vocoder is learned, for example, the intermediate representation extracted on the basis of the target signal “x” is used as the target intermediate representation “s”.

As the adversarial loss function, an adversarial loss function based on an arbitrary measure may be used. In other words, a function based on a least squares adversarial loss function (LSGAN) as in Expressions (1) and (2), a function based on a Wasserstein adversarial loss function (Wasserstein GAN), a function based on a non-saturating adversarial loss function (non-saturating GAN), a function based on a hinge adversarial loss function (hinge GAN), or a combination thereof may be used as the adversarial loss function.

The identifier “D” minimizes the value of Expression (1), thereby causing the real target signal “x” and the fake (product) target signal “G(s)” to separate. On the other hand, the group of the signal generation devices 11 minimizes the value of Expression (2), thereby causing the real target signal “x” and the false target signal “G(s)” to approach each other.

Here, the adversarial generation network of the signal generation system is optimized under the condition that the identifier “D” and the group “G” of the signal generation devices 11 oppose (compete with) each other. The group “G” of the signal generation devices 11 can thus generate a target signal “G(s)” from which the identifier “D” cannot identify whether or not the signal is the real target signal “x”.

In order to stabilize the machine learning of the group of signal generation devices 11, an intermediate representation-matching loss function “Lᵢₙ(G)” expressed as Expression (3) and an adversarial loss function may be used.

$$\begin{matrix}[ Math . 3 ] & \\ {ℒ}_{i m} ( G ) = {𝔼}_{( x , s )} [ {‖ ϕ ( x ) - ϕ ( G ( s ) ) ‖}_{1} ] , & ( 3 )\end{matrix}$$

Here, “φ” represents a function that extracts the target intermediate representation (target feature) from the target signal. In other words, “φ(x)” represents a real target intermediate representation extracted from the real target signal “x”. “φ(G(s))” represents a fake target intermediate representation extracted from the fake target signal “G(s)”. Note that although an L1 distance is used as an example of a reference to cause the real target intermediate representation “φ(G(x))” and the fake target intermediate representation “φ(G(s))” to approach each other in Expression (3), an arbitrary measure (for example, an L2 distance, a Wasserstein distance, a hinge function, or a combination thereof) may be used as an example of the reference.

It is possible to bring the fake target signal “G(s)” close to the real target signal “x”, which is the target of the fake target signal, in the feature space of the intermediate representation by using the intermediate representation-matching loss function for the machine learning,

In order to stabilize the machine learning of the identifier and the group of the signal generation devices 11, a feature-matching loss function “L_{fn}(G; D)” represented by Expression (4) may be used in addition to any loss function out of the above loss functions.

$$\begin{matrix}[ Math . 4 ] & \\ {ℒ}_{f m} ( G ; D ) = {𝔼}_{( x , s )} [ {\sum }_{i = 1}^{T} \frac{1}{{N}_{i}} {‖ {D}^{i} ( X ) - {D}^{i} ( G ( s ) ) ‖}_{1} ] , & ( 4 )\end{matrix}$$

Here, “T” represents the number of layers of the identifier “D”. “Dⁱ” represents a feature of the i-th layer of the identifier “D”. “Nᵢ” represents the number of features of the i-th layer of the identifier “D”. Although the L1 distance is used as an example in Expression (4), an arbitrary measure (for example, an L2 distance, a Wasserstein distance, a hinge function, or a combination thereof) may be used. In addition, although the features of all the layers in the identifier “D” are used for the machine learning as an example in Expression (4), only features of some of the layers in the identifier “D” may be used for the machine learning. It is possible to bring the fake target signal “G(s)” close to the real target signal “x”, which is the target of the fake target signal, in the feature space of the identifier using the feature-matching loss function for the machine learning.

As expressed as an example in Expression (5), the loss function as a combination of three types of loss functions is used as a final loss function “L_{G}” of the signal generation device 11 “G” in the embodiment.

$$\begin{matrix}[ Math . 5 ] & \\ {ℒ}_{G} = {ℒ}_{a d v} ( G ; D ) + {λ}_{f m} {ℒ}_{f m} ( G ; D ) + {λ}_{i m} {ℒ}_{im} ( G ) & ( 5 )\end{matrix}$$

As expressed as an example in Expression (6), an adversarial loss function is used as a final loss function “L_{D}” of the identifier “D”.

$$\begin{matrix}[ Math . 6 ] & \\ {ℒ}_{D} = {ℒ}_{a d v} ( D ; G ) & ( 6 )\end{matrix}$$

Here, “λ_{fm}” is a weighting parameter for the loss function “L_{fm}(G; D)”. “λᵢₘ” is a weighting parameter for the loss function “Lᵢₘ(G)”. The machine learning model of the group “G” of the signal generation devices 11 is optimized by minimizing the loss function “L_{G}”. The machine learning model of the identifier “D” is optimized by minimizing the loss function “L_{D}”.

Note that all of the three types of loss functions expressed as examples in Expressions (5) and (6) may be used for the machine learning, or some of the three types of loss functions may be used for the machine learning.

Next, a configuration example of the signal generation device 11 will be described.

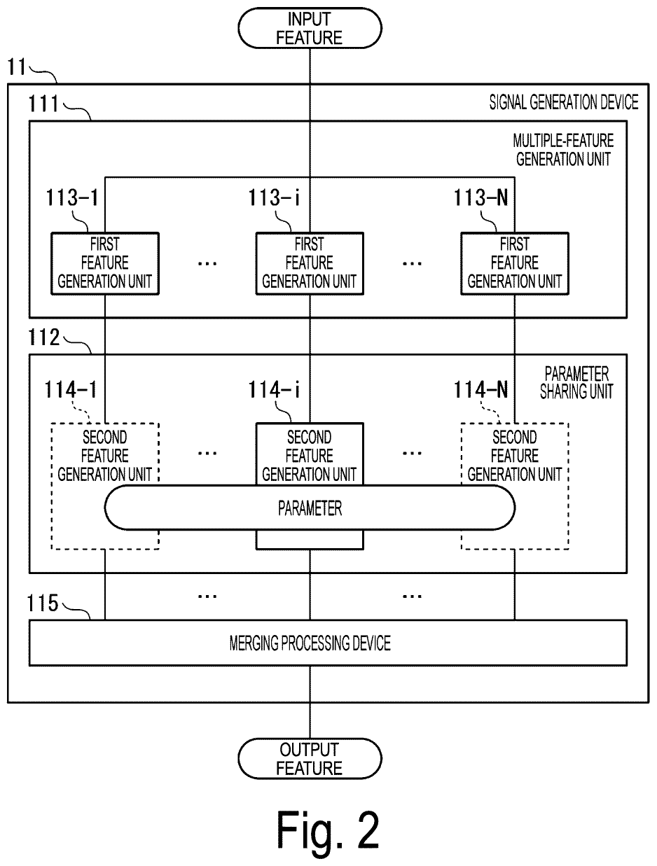

FIG. 2 is a diagram illustrating a configuration example of the signal generation device 11 (module) in the first embodiment. The signal generation device 11 includes a multiple-feature generation unit 111. The signal generation device 11 includes a parameter sharing unit 112 that shares at least some of parameters. Also, the signal generation device 11 includes a merging processing device 115.

In a case where the size of an input signal of the signal generation system 1a is different from the size of an output signal of the signal generation system 1a, in a case where the size of the input signal or the size of the output signal of the signal generation system in the comparative example is different from the size of the intermediate representation of the signal generation system in the comparative example, or in a case where reduction or extension of information regarding a predetermined dimension is performed, the signal generation system 1 may further include one or more modules (not illustrated) that execute upsampling processing or downsampling processing on a feature of arbitrary one or more stages from the input stage to the output stage of the signal generation system. The upsampling processing or the downsampling processing may be executed a plurality of times in a divided manner. The signal generation system 1a may further include a module (signal generation device) that executes other processing.

Furthermore, the multiple-feature generation unit 111, the parameter sharing unit 112, and a neural network (for example, a convolutional neural network, a recurrent neural network, a transformer network, an attention network, or a fully connected neural network) with another configuration may be combined in the signal generation device 11.

The multiple-feature generation unit 111 (variation generation unit) includes N different first feature generation units 113. The N different first feature generation units 113 include N different first neural networks “fᵢ” (i={1, . . . , N}) of a machine learning model. Here, “N” represents the number of first neural networks used in parallel. In other words, “N” is the number of multiple-feature generation units 111. The first neural networks “fᵢ” are neural network (neural networks with a smaller model size) that are lighter than the second neural networks “gᵢ” (i={1, . . . , N}) in the parameter sharing unit 112. For example, “fᵢ” is a one-dimensional convolutional neural network with a smaller kernel size than that of “gᵢ”, a one-dimensional convolutional neural network with a smaller total number of convolutional layers than that of “gᵢ”, or a one-dimensional convolutional neural network with a smaller number of connections of the convolutional layers in the channel direction than that of “gᵢ”.

In the above “processing B1”, the multiple-feature generation unit 111 acquires input features “hⁱⁿ” from the preceding stage. The multiple-feature generation unit 111 generates a plurality of different first intermediate features “h¹ᵢ=fᵢ(hⁱⁿ)” on the basis of the input features “hⁱⁿ” using the plurality of different first neural networks “fᵢ”. The multiple-feature generation unit 111 thus increases variations of the input features. In other words, the multiple-feature generation unit 111 generates the N different first intermediate features “h¹ᵢ” as N variations (diversity) of the input features “hⁱⁿ”.

The parameter sharing unit 112 includes N second feature generation units 114. The N second feature generation units 114 includes N second neural networks “gᵢ” of a machine learning model. At least some of the N second neural networks share parameters. An increase in number of the parameters of the second neural networks is thus curbed.

Here, since the N second neural networks are the same in a case where all the N second neural networks “gᵢ” share the parameters, the number of the parameters of the second neural networks is curbed to one out of N. In a case where all of “N=3” second neural networks “gᵢ” share the parameters, for example, the number of the parameters of the second neural networks is curbed to one third.

Each second neural network “gᵢ” may have units (layers) such as one or more convolutional layers (for example, one-dimensional convolutional layers) or one or more activation function layers (for example, rectified linear unit layers (ReLUs) or a leaky-rectified linear unit layer (Leaky ReLU)) in an arbitrary order. Furthermore, each neural network “gᵢ” may have a recurrent neural network, a transformer network, an attention neural network, a fully connected neural network, or a combination thereof.

Dilate convolutional layers may be used as some or all of the convolutional layers of the parameter sharing unit 112. It is thus possible to expand the receptive field of the convolutional neural network even in the case where the number of parameters of the convolutional neural network is less than a predetermined number.

In the above “processing B2”, the parameter sharing unit 112 generates N different second intermediate features “h²ᵢ=gᵢ(h¹ᵢ)” on the basis of the N different first intermediate features “h¹ᵢ” using N second neural networks “gᵢ”.

Note that the parameter sharing unit 112 may add N different second intermediate features (a plurality of different features A) and a result (a plurality of different features B) of transformation such as identity transform or linear transform for the N different first intermediate features. It is thus possible to model a residual of the input signal. The processing of executing the residual modeling once in the input/output of the second neural network “gᵢ” has been described above as an example. The present invention is not limited thereto, and the residual modeling may be executed once or more between one or more layers determined in advance in the case where the second neural network “gᵢ” is a multilayer neural network, for example. The residual modeling may be similarly executed in a case where a neural network is used in the multiple-feature generation unit 111 or the merging processing device 115.

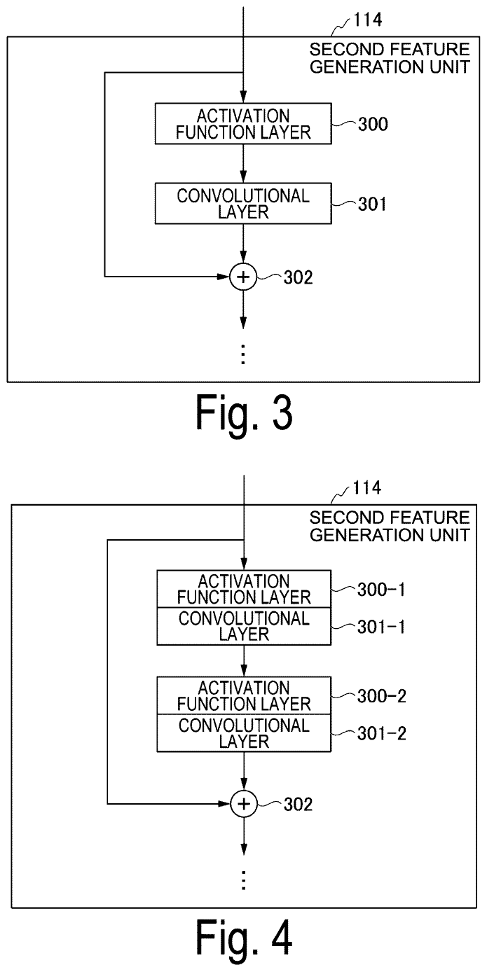

FIG. 3 is a diagram illustrating a first example of a neural network that executes residual modeling processing according to the first embodiment. In FIG. 3, the second feature generation unit 114 includes a combination of an activation function layer 300, a convolutional layer 301, and an addition unit 302. The second feature generation unit 114 may include a plurality of such combinations in vertical columns.

The activation function layer 300 executes activation processing on an input feature from the preceding stage. The convolutional layer 301 performs convolution processing on the input feature on which the activation processing has been performed. The addition unit 302 adds the input feature from the previous stage and the input feature on which the convolution processing has been executed.

FIG. 4 is a diagram illustrating a second example of the neural network that executes residual modeling processing according to the first embodiment. In FIG. 4, the second feature generation unit 114 includes a combination of an activation function layer 300-1 and a convolutional layer 301-1, an activation function layer 300-2 and a convolutional layer 301-2, and an addition unit 302. The second feature generation unit 114 may include a plurality of such combinations in vertical columns.

The activation function layer 300-1 executes activation processing on an input feature from the preceding stage. The convolutional layer 301-1 executes convolution processing on the input feature on which the activation processing has been performed by the activation function layer 300-1. The activation function layer 300-2 executes activation processing on an input feature from the convolutional layer 301-1. The convolutional layer 301-2 executes convolution processing on the input feature on which the activation processing has been executed by the activation function layer 300-2. The addition unit 302 adds the input feature from the previous stage and the input feature on which the convolution processing has been executed by the convolutional layer 301-2.

Referring back to FIG. 2, the description of the configuration example of the signal generation device 11 will be continued. The merging processing device 115 (merging processing unit) includes a relatively light neural network. The relatively light neural network is, for example, a one-dimensional convolutional neural network with a small kernel size, a one-dimensional convolutional neural network with a small total number of convolutional layers, or a one-dimensional convolutional neural network with a small number of connections of the convolutional layers in the channel direction.

In the above “processing B3”, the merging processing device 115 merges the N different second intermediate features “h²ᵢ=gᵢ(h¹ᵢ)” (outputs of the second neural networks). The merging processing device 115 generates a result of the merging processing on the N different second intermediate features as an output feature “h^{out}”. The merging processing device 115 outputs the output feature “h^{out}” to the subsequent stage.

As merging processing “k”, the merging processing device 115 executes predetermined transformation processing on a result of combining the N different second intermediate features in the feature dimension direction. The predetermined transformation processing is, for example, identity transform or linear transform. For example, the merging processing device 115 executes the predetermined transformation processing on the result of connecting the N different second intermediate features (the plurality of different features A) using a relatively light neural network.

The merging processing device 115 may generate the output feature “h^{out}” by adding the N different second intermediate features “h²ᵢ” similarly to the addition processing of the addition processing device 102, as the merging processing “k”.

In this manner, the signal generation devices 11 generate the N different first intermediate features “h¹ᵢ” as variations of the input features “hⁱⁿ” using the N different relatively light first neural networks “fᵢ” in the above “processing B1”. In the above “processing B2”, the signal generation devices 11 generate the N different second intermediate features “h²ᵢ=gᵢ (h¹ᵢ)” using the second neural networks “gᵢ” sharing at least some of the parameters with respect to the N different first intermediate features “h¹ᵢ”.

In this manner, it is possible to improve the ability of the machine learning model to express the feature (input feature) of the input signal through an increase in variations of the input feature “hⁱⁿ” while curbing an increase in number of parameters of the second neural networks in the machine learning model by the plurality of second feature generation units 114 in the parameter sharing unit 112 sharing the parameters.

Next, an operation example of each signal generation device 11 will be described.

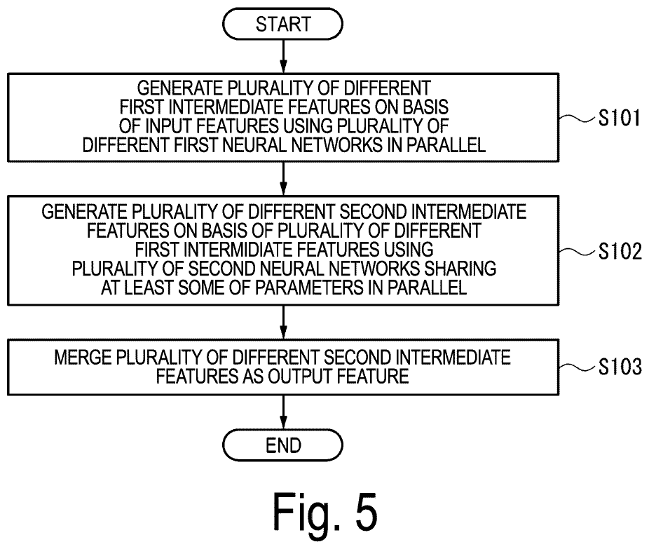

FIG. 5 is a flowchart illustrating an operation example of the signal generation system 1 according to the embodiment. The multiple-feature generation unit 111 generates a plurality of different first intermediate features on the basis of input features from the previous stage using the plurality of different first neural networks in parallel (Step S101).

The parameter sharing unit 112 generates a plurality of different second intermediate features on the basis of the plurality of different first intermediate features using the plurality of second neural networks in parallel (Step S102). The merging processing device 115 merges the plurality of different second intermediate features as an output feature (Step S103).

As described above, the multiple-feature generation unit 111 generates the plurality of different first intermediate features “h¹ᵢ” on the basis of the input features “hⁱⁿ” using the plurality of different first neural networks in parallel. The parameter sharing unit 112 generates the plurality of different second intermediate features “h²ᵢ=gᵢ (h¹ᵢ)” on the basis of the plurality of different first intermediate features “h¹ᵢ” using the plurality of second neural networks “gᵢ” sharing at least some of the parameters in parallel. The merging processing device 115 merges the plurality of different second intermediate features as an output feature. The merging processing device 115 outputs the output feature to the subsequent stage.

It is thus possible to improve the ability of the machine learning model to express the feature of the input signal while curbing an increase in number of parameters of the neural networks in the machine learning model.

### First Modification Example

The first modification example is different from the first embodiment mainly in that the above “processing B1” and the above “processing B2” are executed a plurality of number of times in an arbitrary order and the above “processing B3” is then executed”. In the first modification example, the difference from the first embodiment will be mainly described.

In the above first embodiment, each of the “processing B1” and the “processing B2” is executed only once in this order, and the “processing B3” is then executed. On the other hand, the “processing B1” and the “processing B2” are executed an arbitrary number of times in an arbitrary order, and the “processing B3” is then executed in the first modification example.

In the case where the “processing B1” and the “processing B2” are executed a plurality of times, the number “N” of the neural networks that executes the processing may differ every time the processing is executed.

In the “processing B2”, the parameter sharing method may differ every time the processing is executed. In other words, the parameters of the first neural networks “fᵢ” and the parameters of the second neural networks “gᵢ” may differ every time the processing is executed.

As described above, the number “N” of the neural networks that execute the processing differs every time the processing is performed. Also, the parameters of the first neural networks “fᵢ” and the parameters of the second neural networks “gᵢ” may differ every time the processing is performed.

It is thus possible to improve the ability of the machine learning model to express the feature of the input signal while further curbing an increase in number of the parameters of the neural networks in the machine learning model.

### Second Modification Example

The second modification example is different from the first embodiment mainly in that at least some of the first intermediate features input to the one or more second feature generation units 114 sharing the parameters are integrated in one piece of tensor data and the parameters shared by the second feature generation unit 114 are collectively applied. In the second modification example, the difference from the first embodiment will be mainly described.

In the above first embodiment, the plurality of second neural networks simply share the parameters in the above “processing B2”, and the N second neural networks are used in the “processing B2”, an arithmetic operation time in the “processing B2” is as N times as long as that in a case where “N=1” second neural networks are used in the “processing B2”.

Thus, the different first intermediate features that are inputs to the one or more second feature generation units 114 sharing the parameters from among the N second feature generation units 114 are integrated into one piece of tensor data by the parameter sharing unit 112, for example, in the second modification example. The multiple-feature generation unit 111 may integrate the above different first intermediate features into one piece of tensor data. The integrated tensor data is input to the one or more second feature generation units 114 sharing the parameters from among the N second feature generation units 114 (second neural networks) and is collectively processed.

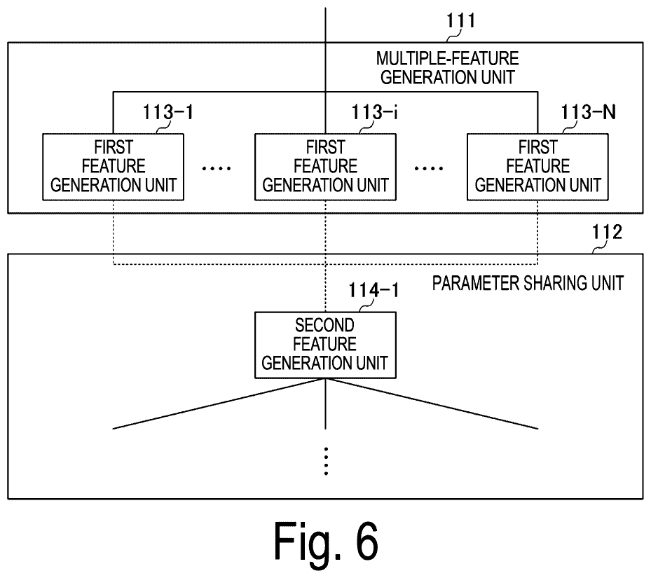

FIG. 6 is a diagram illustrating a configuration example of each signal generation device 11 in a case where all parameters are shared in the one same stage in the second modification example of the first embodiment. In FIG. 6, a second feature generation unit 114-1 (parameter sharing section) shares parameters in advance with another second feature generation unit 114 (not illustrated) in the same stage as the stage of the second feature generation unit 114-1. The second feature generation unit 114-1 integrates N different first intermediate features generated by the N first feature generation units 113 into one piece of tensor data. The second feature generation unit 114-1 collectively generates the N different second intermediate features on the basis of the tensor data. The second feature generation unit 114-1 outputs the N different second intermediate features to the N second feature generation units 114-2 (not illustrated) in the subsequent stage or the merging processing device 115.

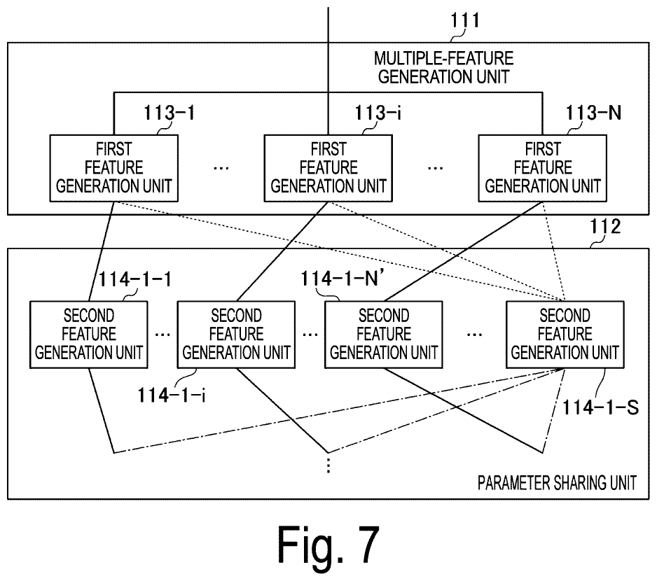

FIG. 7 is a diagram illustrating a configuration example of the signal generation device 11 in a case where some of parameters are shared in another same stage in the second modification example of the first embodiment. FIG. 7 illustrates a result obtained by dividing the N second feature generation units 114-1 in the parameter sharing unit 112 illustrated as an example in FIG. 2 into parameter non-sharing sections and parameter sharing sections and then integrating the divided N parameter sharing sections. In FIG. 7, each of the second feature generation unit 114-1-1 to the second feature generation unit 114-1-N′ is the parameter non-sharing section. Also, each of N″ second feature generation units 114-1-S is the parameter sharing section. Here, “N″” is an integer that is equal to or greater than one and is one as an example in FIG. 7.

The second feature generation units 114-1-S integrate inputs (first intermediate features) of the second feature generation units 114-1 sharing parameters with the second feature generation units 114-1-S into one piece of tensor data from among the N different first intermediate features generated by the N first feature generation units 113. The second feature generation unit 114-1-S collectively generates outputs (second intermediate features) of the second feature generation units 114-1 sharing the parameters with the second feature generation units 114-1-S on the basis of the tensor data in accordance with inputs (first intermediate features) of the second feature generation units 114-1 sharing the parameters with the second feature generation units 114-1-S. The second feature generation units 114-1-S outputs the outputs (second intermediate features) of the second feature generation units 114-1 sharing the parameters with the second feature generation units 114-1-S to the second feature generation units 114-2 (not illustrated) in the subsequent stage or the merging processing device 115.

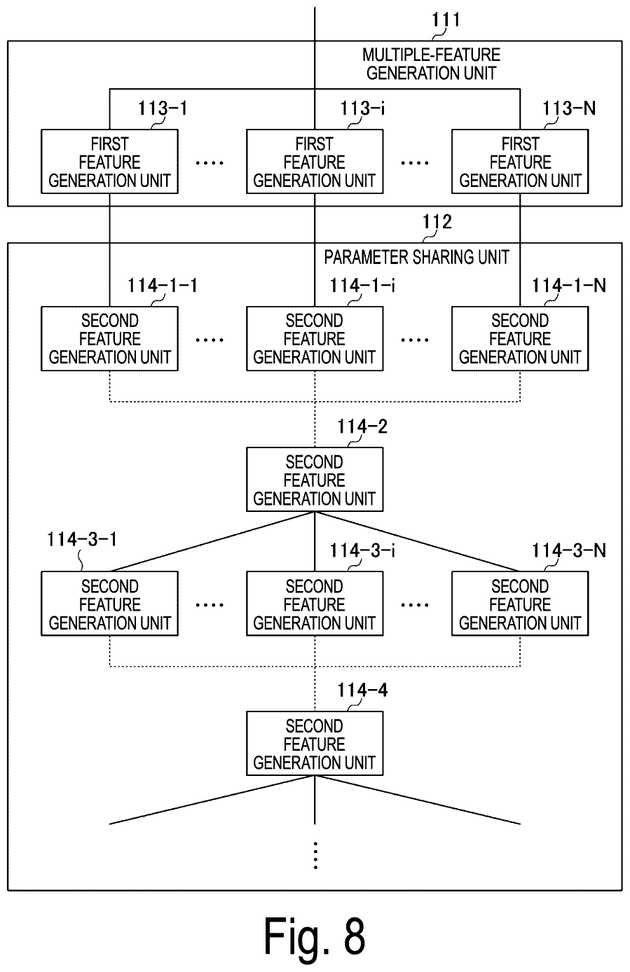

FIG. 8 is a diagram illustrating a configuration example of the signal generation device 11 in a case where all parameters are shared in a predetermined same stage and some of parameters are shared in another same stage according to the second modification example of the first embodiment. In FIG. 8, the second feature generation units 114-2 share the parameters with other second feature generation units 114-2 (not illustrated) in the same stage as the stage of the second feature generation units 114-2 in advance. Also, the second feature generation units 114-4 share the parameters with other second feature generation units 114-4 (not illustrated) in the same stage as the stage of the second feature generation units 114-4 in advance.

The second feature generation units 114-1 may not share the parameters with other second feature generation units 114-1 in the same stage as the stage of the second feature generation units 114-1. For example, a second feature generation unit 114-1-1 may not share the parameters with a second feature generation unit 114-1-N. The second feature generation units 114-3 may not share the parameters in other second feature generation units 114-3 in the same stage as the stage of the second feature generation units 114-3. For example, a second feature generation unit 114-3-1 may not share the parameters with a second feature generation unit 114-3-N.

The N second feature generation units 114-1 generate N different second intermediate features on the basis of the N different first intermediate features generated by the N first feature generation units 113. The second feature generation units 114-2 integrate the N different second intermediate features generated by the N second feature generation units 114-1 into one piece of tensor data. The second feature generation units 114-2 collectively generate N new different second intermediate features on the basis of the tensor data.

The second feature generation units 114-3 operate similarly to the second feature generation units 114-1 on the basis of the N new different second intermediate features. Also, the second feature generation units 114-2 operate similarly to the second feature generation units 114-4.

Note that the configuration of the signal generation system illustrated in the present embodiment is an illustrative configuration, and a specific configuration of the signal generation system is not limited to the configuration illustrated in the present embodiment. For example, the second feature generation units 114 may integrate the second intermediate features that are inputs to parameter sharing sections into one piece of tensor data for each of the parameter sharing section in an arbitrary stage and with an arbitrary number and collectively generate new second intermediate features on the basis of the tensor data.

As described above, the parameter sharing unit 112 integrates at least some of the plurality of different first intermediate features (the plurality of first intermediate features input to the second feature generation units 114 sharing the parameters) into one piece of tensor data. The parameter sharing unit 112 collectively generates at least some (outputs of the second feature generation units 114 sharing the parameters) of the plurality of different second intermediate features on the basis of the tensor data.

It is thus possible to collectively execute an arithmetic operation on the tensor data using an arithmetic operation device (for example, a graphics processing unit (GPU)) specialized for tensor operations and thereby to execute the “processing B2” at a higher speed as compared with a case where the arithmetic operations on the N different first intermediate features are successively executed.

Furthermore, the entire “processing B2” may be collectively executed using the arithmetic operation device specialized for tensor operations in the N second neural networks. It is thus possible to execute the “processing B2” at a yet higher speed.

### Third Modification Example

The third modification example is different from the first embodiment mainly in that input features of multidimensional signals are input to the signal generation devices 11. In the third modification example, the difference from the first embodiment will be mainly described.

In a case where an input feature of a multidimensional signal (L-dimensional signal) of a still image, a moving image, or the like is input to the signal generation devices 11, an L-dimensional convolutional neural network with a small kernel size, an L-dimensional convolutional neural network with a small total number of convolutional layers, or an L-dimensional convolutional neural networks with a small number of connections of the convolutional layers in the channel direction, for example, may be used as the light first neural network in the first feature generation unit 113. Also, an L-dimensional convolutional neural network with a small kernel size, an L-dimensional convolutional neural network with a small total number of convolutional layers, or an L-dimensional convolutional neural network with a small number of connections of the convolutional layers in the channel direction, for example, may be used as a light neural network in the merging processing device 115.

Here, “L” of the L dimensions is the number of dimensions of the input feature, and is, for example, a value that is equal to or less than the number of dimensions of generated data. In a case where an input feature of a multidimensional signal of still image data is input to the signal generation system 1, for example, the number “L” of dimensions is one or two. In a case where an input feature of a multidimensional signal of moving image data is input to the signal generation system 1, for example, the number “L” of dimensions is one, two, or three.

Each second neural networks “gᵢ” may include units (layer) of one or more convolutional layers (for example, L-dimensional convolutional layers) or one or more activation function layers (for example, normalized linear unit layers or leaky normalized linear unit layers) in an arbitrary order. Furthermore, each neural network “gᵢ” may have a recurrent neural network, a transformer network, an attention neural network, a fully connected neural network, or a combination thereof.

### (Example of Advantages)

Next, an example of advantages of the signal generation system 1a will be described.

In an experiment to check the example of advantages, an input sound signal of a speaker (female) was used as learning data for the machine learning model as an example.

A time length of the sound of the input sound signal was about 24 hours as an example. A sampling frequency for the input sound signal was 22.05 kHz as an example. Short-time Fourier transform was executed on the input sound signal. A high-speed Fourier transform size (FFT size) of the short-time Fourier transform was 1024 as an example. A shift width of the short-time Fourier transform was 256 as an example. A window width of the short-time Fourier transform was 1024 as an example.

An intermediate representation was an eighty dimensional log mel spectrogram as an example. The log mel spectrogram was obtained as a result of executing the short-time Fourier transform on the sound signal and transforming the scale.

In the experiment to check the example of advantages, the group “G” of the signal generation devices 11 generating target sound signals (output feature) from target intermediate representations (input features) was trained using the machine learning method. Also, performance of such a group “G” of the signal generation devices 11 was evaluated.

Sound quality was subjectively evaluated using mean opinion scores (MOSs). Levels of the mean opinion scores were five levels. Higher mean opinion scores represent higher sound quality. Here, the score “5” is the highest score while the score “1” is the lowest score.

A processing speed score represents a relative value with respect to a one-time speed (reference speed) of the sound of the input sound signal in the environment where the graphics processing unit (GPU) is executed. Higher processing speed scores represent higher processing speeds of the signal generation system. Scores that are greater than one represent that it is possible to generate a target sound signal (output sound feature) faster than the one-time speed (real time) of the sound of the input sound signal (input sound feature).

A neural network size (model size) score in the machine learning model represents the number of parameters in the neural network. Smaller size scores represent smaller neural network sizes.

Hereinafter, the signal generation method in the signal generation system in the comparative example will be referred to as a “baseline method”.

Hereinafter, the signal generation method in which the parameters are simply shared by the plurality of second neural networks and all the second neural networks are used in the “processing B2” as in the first embodiment will be referred to as a “first generation method”.

Hereinafter, the signal generation method in which the input features of all the second neural networks are integrated into one piece of tensor data and the one piece of tensor data are collectively input to all the second neural networks as in the second modification example of the first embodiment will be referred to as a “second generation method”.

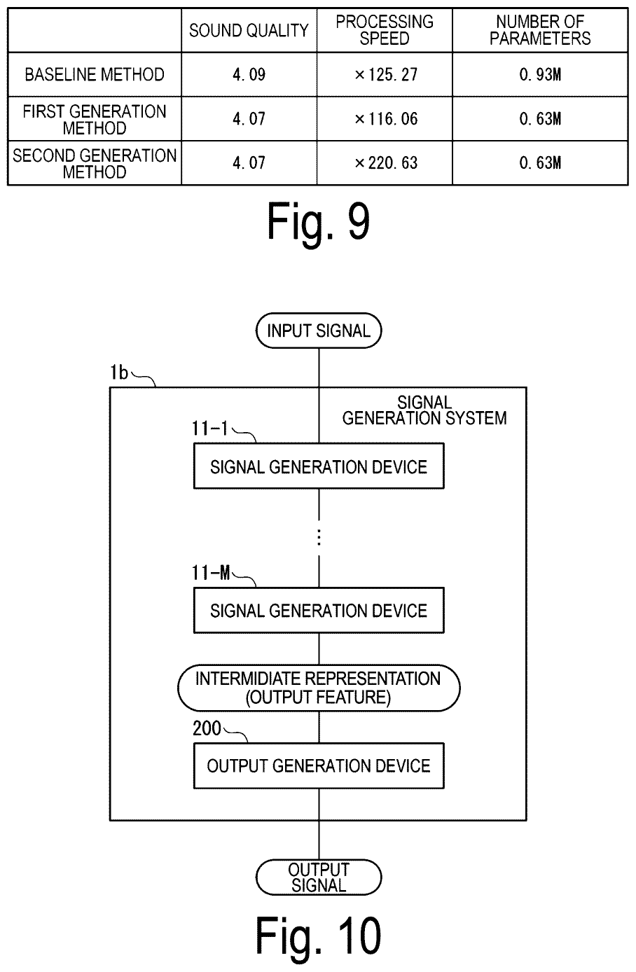

FIG. 9 is a diagram illustrating an example of advantages (a result of an experimental example)) of the signal generation systems in the comparative example (baseline method), the first embodiment (first generation method), and the second modification example (second generation method). Sound quality obtained by the first generation method and sound quality obtained by the second generation method are equivalent to the sound quality obtained by the baseline method. A processing speed obtained by the first generation method is equivalent to the processing speed obtained by the baseline method. A processing speed obtained by the second generation method is higher than the processing speed obtained by the baseline method. Also, the number of parameters in the first generation method and the number of parameters in the second generation method are smaller than the number of parameters in the baseline method. In other words, all of the sound quality obtained by the baseline method, the sound quality obtained by the first generation method, and the sound quality obtained by the second generation method are equivalent, and each of the model size in the first generation method and the model size in the second generation method is smaller than the model size in the base line. Also, the processing speed obtained in the second generation method is the highest.

In this manner, it is possible to improve the ability of the machine learning model to express the feature of the input sound signal while curbing the increase in number of parameters as compared with the baseline method and to obtain sound quality equivalent to that obtained by the baseline method, according to the first generation method and the second generation method. Also, it is possible to further improve the processing speed by the tensor data being integrated as in the second modification example.

### Second Embodiment

The second embodiment is different from the first embodiment mainly in that each signal generation device 11 executes the above “processing A1”. In the second embodiment, the difference from the first embodiment will be mainly described.

FIG. 10 is a diagram illustrating a configuration example of a signal generation system 1b according to the second embodiment. The signal generation system 1b is a system that generates an output signal (target signal) on the basis of an arbitrary input signal. The signal generation system 1b includes an output generation device 200 and M signal generation devices 11 in vertical columns. Note that the signal generation system 1b may further include one or more signal generation devices 10 in a vertical column with respect to the signal generation devices 11. Also, the signal generation system 1b may include one or more signal generation devices (for example, neural networks or signal processing functions) other than the signal generation device 10 and the signal generation devices 11 at one or more arbitrary locations (in a preceding stage or a subsequent stage of the signal generation devices 11 at predetermined one or more locations, for example).

In the second embodiment, the signal generation system 1b explicitly estimates intermediate representations (target intermediate representations) on the basis of an input signal and generates an output signal (target signal) on the basis of the estimated intermediate representations (target intermediate representations). A signal generation device 11-1 generates an output feature on the basis of the input signal in the above “processing A1”. A signal generation device 11-M generates an intermediate representation (for example, a spectrogram) on the basis of an input feature from a signal generation device 11-(M-1) in the above “processing A1”. An output generation device 200 generates an output signal on the basis of the intermediate representation generated by the signal generation device 11-M (the output feature of the signal generation device 11-M) in the above “processing A2”.

It is thus possible to improve the ability of the machine learning model to express the feature of the input signal while curbing an increase in number of parameters of the neural networks in the machine learning model.

### Third Embodiment

The third embodiment is different from the first embodiment and the second embodiment mainly in that the above “processing A1” and the above “processing A2” are executed as consistent processing. In the third embodiment, the difference from the first and second embodiments will be mainly described.

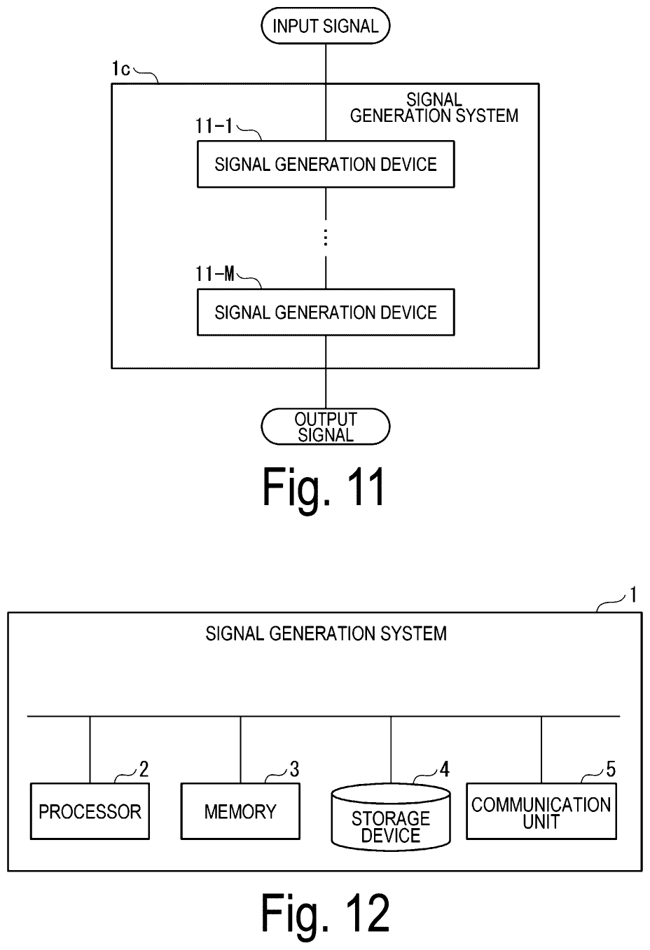

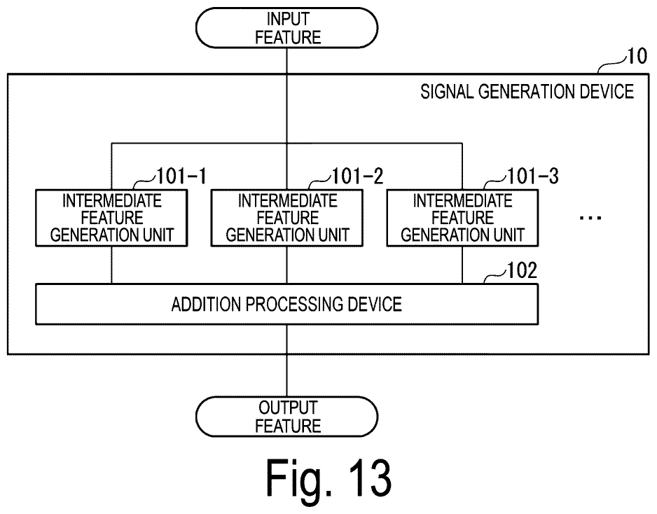

FIG. 11 is a diagram illustrating a configuration example of a signal generation system 1c according to the third embodiment. The signal generation system 1c is a system that generates an output signal (target signal) on the basis of an arbitrary input signal. The signal generation system 1c includes M signal generation devices 11 in vertical columns. Note that the signal generation system 1c may further include one or more signal generation devices 10 in vertical columns with respect to the signal generation devices 11. Also, the signal generation system 1c may include one or more signal generation devices (for example, neural networks or signal processing functions) other than the signal generation device 10 and the signal generation devices 11 at one or more arbitrary locations (in a preceding stage or a subsequent stage of the signal generation device 11 at a certain location, for example).

In the third embodiment, the signal generation system 1c generates the output signal (target signal) on the basis of the input signal without explicitly estimating any intermediate representation (target intermediate representation) on the basis of the input signal. A signal generation device 11-1 generates an output feature on the basis of the input signal. A signal generation device 11-M generates an output signal (an output feature of the signal generation device 11-M) on the basis of an input feature from a signal generation device 11-(M−1) (an output feature of the signal generation device 11-(M−1)).

It is thus possible to improve the ability of the machine learning model to express the feature of the input signal while curbing an increase in number of parameters of the neural networks in the machine learning model.

### (Hardware Configuration Example)

FIG. 12 is a diagram illustrating a hardware configuration example of the signal generation system 1 according to each of the embodiments. The signal generation system 1 corresponds to each of the signal generation system 1a, the signal generation system 1b, and the signal generation system 1c. Some of all of the functional units in the signal generation system 1 include a processor 2. The processor 2 such as a central processing unit (CPU) or a GPU is realized as software by executing programs stored in a storage device 4 including a nonvolatile recording medium (non-transitory recording medium) and a memory 3. The program may be recorded in a computer-readable non-transitory recording medium. The program may be a multi-threaded program. The computer-readable non-transitory recording medium is, for example, a non-transitory recording medium such as a portable medium such as a flexible disk, a magneto-optical disc, a read only memory (ROM), or a compact disc read only memory (CD-ROM) or a storage device such as a hard disk or a solid state drive incorporated in a computer system. A communication unit 5 performs predetermined communication processing.

At least some of the functional units in the signal generation system 1 may be analog circuits or digital circuits. At least some of the functional units in the signal generation system 1 may be realized by using hardware including an electronic circuit (or circuitry) using, for example, a large scale integrated circuit (LSI), an application specific integrated circuit (ASIC), a programmable logic device (PLD), or a field programmable gate array (FPGA).

Although the embodiments of the present invention have been described in detail with reference to the drawings, specific configurations are not limited to the embodiments and include design and the like within the gist of the present invention.

### INDUSTRIAL APPLICABILITY

The present invention can be applied to a system that generates a target signal from an input signal.

### REFERENCE SIGNS LIST

1, 1a, 1b, 1c Signal generation system
2 Processor
3 Memory
4 Storage device
5 Communication unit
10 Signal generation device
11 Signal generation device
100 Representation generation device
101 Intermediate feature generation unit
102 Addition processing device
111 Multiple-feature generation unit
112 Parameter sharing unit
113 First feature generation unit
114 Second feature generation unit
115 Merging processing device
200 Output generation device
300 Activation function layer
301 Convolutional layer
302 Addition unit

1. A signal generation device comprising:
a multiple-feature generator that generates a plurality of different first intermediate features on the basis of input features using a plurality of different first neural networks in parallel;
a parameter sharer that generates a plurality of different second intermediate features on the basis of the plurality of different first intermediate features using a plurality of second neural networks sharing at least some of parameters in parallel; and
a merging processor that merges the plurality of different second intermediate features as an output feature.

2. The signal generation device according to claim 1,
wherein the parameter sharer collects at least some of the plurality of different first intermediate features into tensor data, and collectively generates at least some of the plurality of different second intermediate features on the basis of the tensor data.

3. The signal generation device according to claim 1, wherein a model size of a first neural network from among the plurality of different first neural networks is smaller than a model size of a second neural network from among the plurality of second neural networks.

4. A signal generation system comprising: one or more signal generation devices,
wherein the signal generation device includes
a multiple-feature generator that generates a plurality of different first intermediate features on the basis of input features using a plurality of different first neural networks in parallel,
a parameter sharer that generates a plurality of different second intermediate features on the basis of the plurality of different first intermediate features using a plurality of second neural networks sharing at least some of parameters in parallel, and
a merging processor that merges the plurality of different second intermediate features as an output feature.

5. A signal generation method that is executed by a signal generation device, the method comprising:
a step of generating a plurality of different first intermediate features on the basis of input features using a plurality of different first neural networks in parallel;
a step of generating a plurality of different second intermediate features on the basis of the plurality of different first intermediate features using a plurality of second neural networks sharing at least some of parameters; and
a step of merging the plurality of different second intermediate features as an output feature.

6. A program that causes a computer to execute:
a procedure of generating a plurality of different first intermediate features on the basis of input features using a plurality of different first neural networks in parallel;
a procedure of generating a plurality of different second intermediate features on the basis of the plurality of different first intermediate features using a plurality of second neural networks sharing at least some of parameters; and
a procedure of merging the plurality of different second intermediate features as an output feature.
